(19) United States
(12) Patent Application Publication
(10) Pub. No.: US 2016/0006635 A1
(43) Pub. Date: Jan. 7, 2016

(54) MONITORING METHOD AND MONITORING SYSTEM

(71) Applicant: HITACHI, LTD., Chiyoda-ku, Tokyo (JP)

(72) Inventors: Shinichi YOKOTA, Tokyo (JP); Masaru TAMAKI, Tokyo (JP); Toshimichi SASAGE, Tokyo (JP)

(73) Assignee: HITACHI, LTD., Tokyo (JP)

(21) Appl. No.: 14/771,344

(22) PCT Filed: Dec. 25, 2013
(86) PCT No.: PCT/JP2013/084584

§ 371 Date: Aug. 28, 2015

(51) Int. Cl. H04L 12/26; H04L 12/851; H04L 29/08; H04L 12/911

(52) U.S. Cl. CPC H04L 43/0888; H04L 47/821; H04L 47/2425; H04L 67/02

(57) ABSTRACT

A monitoring method and system avoid the occurrence of waiting due to deadlock, and thereby avoid the occurrence of job delays. An information system includes a job scheduling device which receives a request, and an analyzing device which retains first information related to the exclusive relation between jobs and a load tendency of each of the jobs. The job scheduling device makes an inquiry to the analyzing device with respect to which business device the request should be transferred. The analyzing device notifies the job scheduling device of the business device to which the request should be transferred and, as needed, a standby time, and the job scheduling device transfers the request to the designated business device after standing by for the designated standby time, in case the standby time is designated, based on the notice from the analyzing device.

### TECHNICAL FIELD

The present invention relates to a monitoring method and a monitoring system and, for instance, can be suitably applied to an information system comprising a business device capable of executing a plurality of job programs (this is hereinafter simply referred to as “jobs”).

### BACKGROUND ART

In recent years, information systems have assumed an increasingly important position as the foundation of corporate activities and social infrastructures, and failures that occur in such information systems can no longer be overlooked. In other words, examples where events such as a system crash in which the information system becomes inoperable or cases where the use of an online system becomes difficult due to the drastic deterioration in the response performance, which result from the occurrence of the foregoing failures, have a significant impact on the economy and society are now occurring from time to time.

Under the foregoing circumstances, in recent years, efforts are being yielded for indirectly maintaining the SLA (Service Level Agreement) of jobs by setting the correlation of threshold values or operating statuses in the respective business device units configuring the information system, and monitoring the robustness of the respective business devices.

### CITATION LIST

[Non-Patent Literature]

[NPTL 1] “WebSAM Invariant Analyzer”, [online], NEC, [searched on Nov. 26, 2013], Internet <URL: http://jpn.nec.com/websam/invariantanalyzer/>

### SUMMARY OF INVENTION

### Technical Problem

However, for instance, under an environment where a plurality of job programs are being run in parallel on one system, there are cases where a deadlock occurs as a result of the job programs, which are being run in parallel, using the same file, and the jobs are consequently delayed. In this case, since the failure is not caused by the load of the business devices configuring the system, this problem cannot be prevented by monitoring the correlation of threshold values or operating statuses based on the conventional method described above.

The present invention was devised in view of the foregoing points, and an object of this invention is to reduce the occurrence of deadlocks and exclusive waiting, and thereby reduce the occurrence of job delays.

### Solution to Problem

In order to achieve the foregoing object, the present invention provides monitoring method of monitoring an information system including one or more business devices capable of executing a plurality of jobs having an exclusive relation, and a business terminal for requesting execution of the jobs to the business device, wherein the information system includes: a job scheduling device which receives a job execution request sent from the business terminal; and an analyzing device which retains first information related to the exclusive relation between the jobs and a load tendency of each of the jobs, wherein the monitoring method comprises: a first step of the job scheduling device making an inquiry to the analyzing device regarding to which one of the business devices the request from the business terminal should be transferred; a second step of the analyzing device acquiring second information related to an operating status of the business device from the operating status collection device of the monitoring target system, and notifying to the job scheduling device, based on the acquired second information and the retained first information, the business device to which the request should be transferred and, as needed, a standby time that is required upon transferring the request; and a third step of the job scheduling device transferring the request to the designated business device after standing by for the designated standby time, in case the standby time is designated, based on the notice from the analyzing device.

Moreover, the present invention additionally provides a monitoring system for monitoring an information system including one or more business devices capable of executing a plurality of jobs having an exclusive relation, and a business terminal for requesting execution of the jobs to the business device, wherein the monitoring system comprises: a job scheduling device which receives a job execution request sent from the business terminal; and an analyzing device which retains first information related to the exclusive relation between jobs and a load tendency of each of the jobs, wherein the job scheduling device makes an inquiry to the analyzing device regarding to which one of the business devices the request from the business terminal should be transferred; the analyzing device acquires second information related to an operating status of the business device from the operating status collection device of the monitoring target system, and notifies to the job scheduling device, based on the acquired second information and the retained first information, the business device to which the request should be transferred and, as needed, a standby time that is required upon transferring the request; and the job scheduling device transfers the request to the designated business device after standing by for the designated standby time, in case the standby time is designated, based on the notice from the analyzing device.

### Advantageous Effects of Invention

According to the present invention, it is possible to realize a monitoring method and a monitoring system capable of reducing the occurrence of deadlocks and exclusive waiting, and thereby reducing the occurrence of job delays.

### BRIEF DESCRIPTION OF DRAWINGS

FIG. 1 is a block diagram showing the overall configuration of the information system according to this embodiment.

FIG. 2 is a block diagram showing the schematic configuration of the monitoring target system.

FIG. 3 is a block diagram showing the schematic configuration of the job scheduling device.

FIG. 4 is a block diagram showing the schematic configuration of the analyzing device.

FIG. 5 is a conceptual diagram showing the configuration of the job correlation management table.

FIG. 6(A) to FIG. 6(C) are characteristic curve diagrams showing the state of change in the load tendency of the individual jobs.

FIG. 7 is a conceptual diagram showing the configuration of the SLA information management table.

FIG. 8 is a conceptual diagram showing the configuration of the operating status information management table.

FIG. 9 is a conceptual diagram showing the configuration of the schedule management table.

FIG. 10 is a conceptual diagram showing the configuration of the standby time management table.

FIG. 11 is a flowchart showing the processing routine of the system monitoring processing.

FIG. 12 is a flowchart showing the processing routine of the schedule creation processing.

FIG. 13 is a flowchart showing the processing routine of the job scheduling processing.

### DESCRIPTION OF EMBODIMENTS

An embodiment of the present invention is now explained in detail with reference to the drawings.

(1) Configuration of Information System in this Embodiment

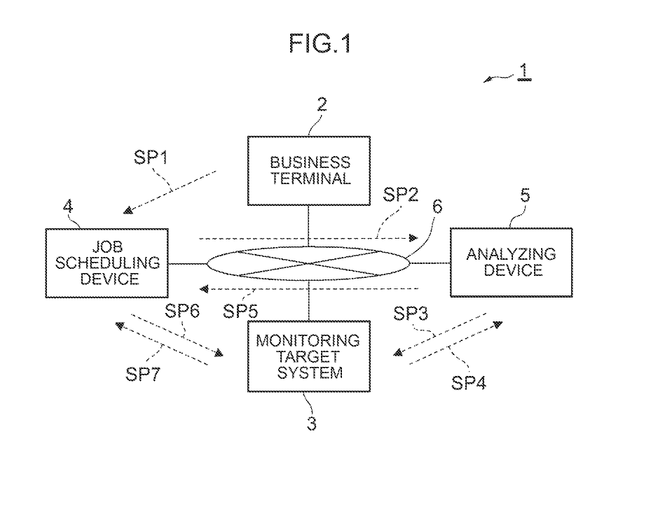

In FIG. 1, reference numeral 1 shows, as a whole, the information system according to this embodiment. The information system 1 is configured by one or more business terminals 2, a monitoring target system 3, a job scheduling device 4 and an analyzing device 5 being mutually connected via a network 6.

The business terminal 2 is a communication terminal that is used by the user for performing jobs, and is configured from, for instance, a PC, a workstation or a mainframe. The business terminal 2 sends, to the job scheduling device 4, a request for executing a job according to the request from the user's operation or installed program.

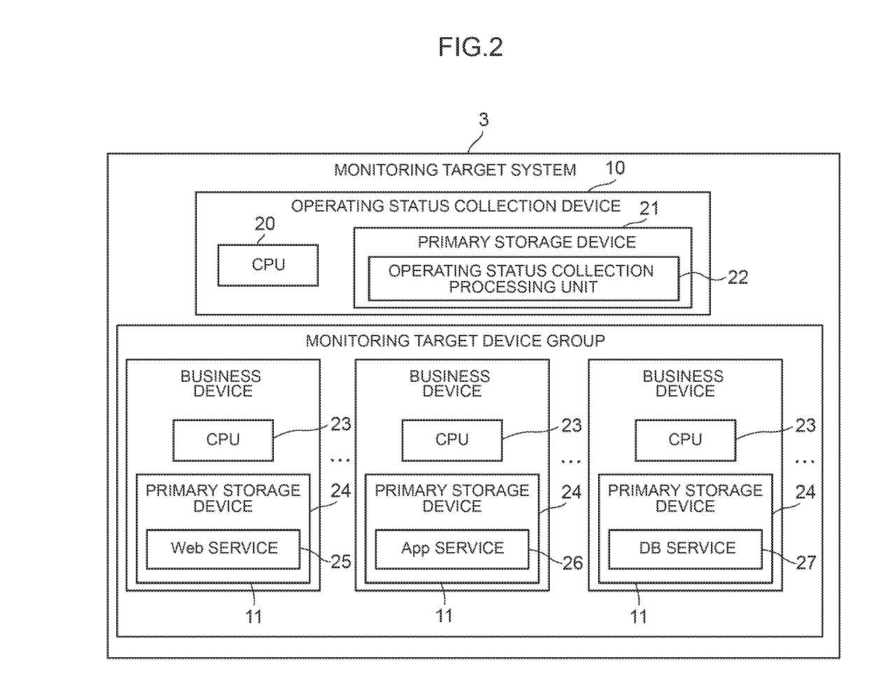

The monitoring target system 3 is configured from, as shown in FIG. 2, an operating status collection device 10, and one or more business devices 11, and the operating status collection device 10 and the respective business devices 11 are mutually connected via a network not shown.

The operating status collection device 10 is a computer system having a function of periodically collecting various types of information related to the operating status of the respective business devices 11 (this is hereinafter referred to as the “operating status information”) such as the CPU utilization and used capacity of the memory of each business device 11, and the elapsed time from the start of processing of the job program (this is hereinafter simply referred to as the “job”) running on the business device 11.

The operating status collection device 10 is configured by comprising a CPU (Central Processing Unit) 20 and a primary storage device 21. The CPU 20 is a processor that governs the operational control of the overall operating status collection device 10. Moreover, the primary storage device 21 is configured from, for example, a semiconductor memory, and is used for storing various programs.

For instance, the primary storage device 21 of the operating status collection device 10 stores an operating status collection processing unit 22, which is a program having a function of collecting operating status information from the business device 11. Furthermore, by periodically executing the operating status collection processing unit 22, the CPU 20 collects, from the respective business devices 11 existing in the monitoring target system 3, the operating status information of such business devices

Each business device 11 is a server device having a function of providing a service in accordance with the request sent from the business terminal 2 via the job scheduling device 4 as described later. Each business device 11 is equipped with a CPU 23 and a primary storage device 24, and the primary storage device 24 stores a Web service program 25, an application program 26 or a database program 27. Furthermore, these programs each execute predetermined processing to attain the objective of a certain job while communicating with each other.

For example, when a request for displaying a predetermined management screen is given from the business terminal 2, the Web service program 25 receives the request and requests the application program 26 to generate screen data of the management screen, the application program 26 requests the database program 27 to acquire the required data from the database and generates the screen data based on the acquired data, and the Web service program 25 sends the generated screen data to the business terminal 2 so as to display, on the business terminal 2, the management screen based on the screen data.

Generally speaking, an application in which multiple programs are distributed and loaded in a plurality of business devices 11 and engage in coordinated operation is referred to as a distributed application. In other words, the monitoring target system 3 of this embodiment is configured as a web three tier model; that is, has a configuration including a web tier, an application tier and a database tier. However, this is merely a configuration example of the monitoring target system 3, and the respective business devices 11 of the monitoring target system 3 may be loaded with programs other than the Web service program 25, the application program 26 or the database program 27.

The job scheduling device 4 is a computer system having a function of making an inquiry, in response to a request from the business terminal 2, to the analyzing device 5 regarding to which business device 11 the request should be transferred and at what timing the request should be transferred, and transferring the request to the business device 11 designated by the analyzing device 5 at the timing that was designated by the analyzing device 5.

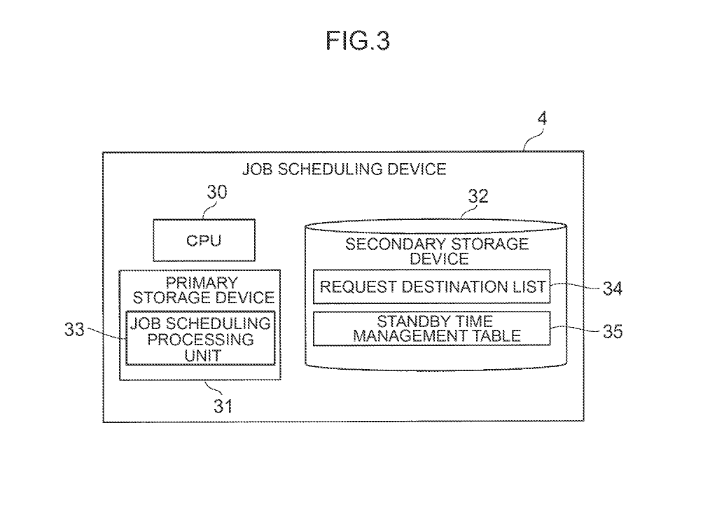

The job scheduling device 4 is configured by comprising, as shown in FIG. 3, a CPU 30, a primary storage device 31 and a secondary storage device 32. The CPU 30 is a processor that governs the operational control of the overall job scheduling device 4. Moreover, the primary storage device 31 is configured from, for example, a semiconductor memory, and is used for storing various programs. The various types of processing of the overall job scheduling device 4 are executed as a result of the CPU 30 executing the various programs stored in the primary storage device 31. The job scheduling processing unit 33 described later is also stored and retained in the primary storage device 31.

The secondary storage device 32 is a large-capacity nonvolatile storage device for storing various programs and various data, and is configured from, for example, a hard disk device. The request destination list 34 and the standby time management table 35 described later are stored and retained in the secondary storage device 32.

The analyzing device 5 is a computer system having a function of deciding, in response to the inquiry from the job scheduling device 4, the business device 11 that should process the request from the business terminal 2, and the timing in which the request should be transferred to that business device 11.

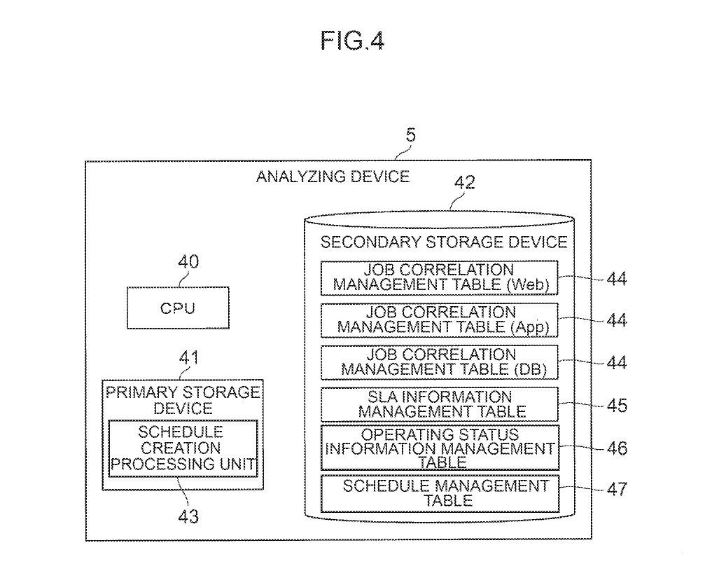

The analyzing device 5 is configured by comprising, as shown in FIG. 4, a CPU 40, a primary storage device 41 and a secondary storage device 42. Since the CPU 40, the primary storage device 41 and the secondary storage device 42 are configured the same as the CPU 30, the primary storage device 31 and the secondary storage device 32 of the job scheduling device 4, the detailed explanation thereof is omitted.

The primary storage device 41 of the analyzing device 5 stores the schedule creation processing unit 43 described later, and the secondary storage device 42 of the analyzing device 5 stores and retains the job correlation table 44, the SLA information management table 45, the operating status information management table 46 and the schedule management table 47, which are all described later.

(2) System Monitoring Processing in this Embodiment

The system monitoring processing of this embodiment to be executed in the information system 1 is now explained. The system monitoring processing is a function of deciding the business device 11 to execute the job requested from the business terminal 2 or the like based on the current operating status of the respective business devices 11 in the monitoring target system 3, and the exclusive relation between jobs and the load tendency of each job, and requesting that business device 11 to execute that job. Here, the phrase “exclusive relation between jobs” means, for example, the existence of exclusivity that arises when the same file is used upon the execution of the job.

In effect, with the information system 1, as shown in FIG. 1, the business terminal 2 sends, to the job scheduling device 4, a request to the business device 11 in the monitoring target system 3 (SP1). Subsequently, when the job scheduling device 4 receives the foregoing request, the job scheduling device 4 sends, to the analyzing device 5, a schedule information request for inquiring on the business device 11 to which the requested job should be requested, and timing that the request should be transferred from the business terminal 2 to the business device 11 (SP2).

When the analyzing device 5 receives the schedule information request from the job scheduling device 4, the analyzing device 5 sends, to the operating status collection device 10 in the monitoring target system 3, an operating status request which requests the transfer of the operating status information of the corresponding business device 11 (SP3). Consequently, the operating status collection device 10 sends the operating status information to the analyzing device 5 in response to the operating status request from the analyzing device 5 (SP4).

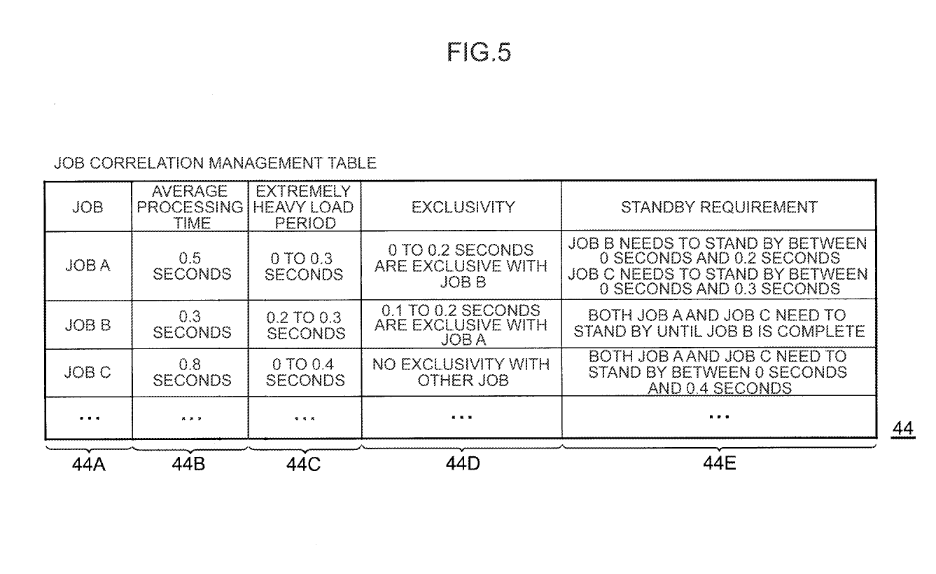

Here, the analyzing device 5 preliminarily retains a job correlation table 44 (FIG. 5) for each service which stores information related to the exclusive relation between jobs executed by the business device 11, and the load tendency upon executing the respective jobs. The job correlation table 44 is a table which preliminarily stores, as described later with reference to FIG. 5, information representing the average processing time for each job, the period that the load of the business device 11 will become extremely heavy when that business device 11 executes that job, exclusivity with other jobs, and, when the business device 11 is executing that job, whether that business device 11 should stand by for executing other jobs.

When the analyzing device 5 receives the operating status information from the operating status collection device 10, the analyzing device 5 determines, based on the received operating status information and the job correlation table 44, whether any one of the business devices 11 can immediately execute the job requested by the business terminal 2. When the analyzing device 5 determines that the job can be immediately executed, the analyzing device 5 notifies the business device 11 to which the execution of that job should be requested, as schedule information, to the job scheduling device 4. Meanwhile, when the analyzing device 5 determines that the job cannot be immediately executed, the analyzing device 5 notifies the standby time and the business device 11 to which the execution of that job should be requested after the lapse of the standby time, as schedule information, to the job scheduling device 4 (SP5).

When the job scheduling device 4 receives the schedule information from the analyzing device 5, the job scheduling device 4 stands by for the period designated in the schedule information as needed based on the received schedule information, and thereafter transfers the request from the business terminal 2 to the business device 11 in the monitoring target system 3 that was designated in the schedule information (SP6).

Consequently, the business device 11 in the monitoring target system 3 that received the foregoing request executes processing according to that request. Moreover, when it is necessary to request a job to another business device 11 in order to process the foregoing request, the business device 11 sends a request to the job scheduling device 4 (SP7).

Subsequently, the job scheduling device 4 that received the request sends, to the analyzing device 5, a schedule information request for inquiring the business device 11 to which the requested job should be requested, and the timing that the request should be transferred to the business device 11 (SP2).

Consequently, the processing of foregoing step SP3 to step SP5 is executed, and thereafter the job scheduling device 4 that received the schedule information from the analyzing device 5 stands by for the period designated in the schedule information as needed based on the received schedule information, and thereafter transfers the request, which was sent from the business terminal 2, to the business device 11 in the monitoring target system 3 that was designated in the schedule information (SP6).

The foregoing processing is repeated in the number of times required, and the processing result of the request from the business terminal 2 is thereafter sent from the corresponding business device 11 to the business terminal 2.

As means for executing the system monitoring processing based on the system monitoring function according to this embodiment described above, as shown in FIG. 4, the primary storage device 41 of the analyzing device 5 stores a schedule creation processing unit 43, and the secondary storage device 42 of the analyzing device 5 stores, for each service, a job correlation table 44, an SLA information management table 45, an operating status information management table 46 and a schedule management table 47.

The schedule creation processing unit 43 is a program having a function of deciding the business device 11 that should execute the requested job and the timing that the request should be transferred to the business device 11 according to the schedule information request from the job scheduling device 4, and notifying the decision, as schedule information, to the job scheduling device 4.

Moreover, the job correlation table 44 is a table that is used for managing information related to the exclusive relation between jobs that are executed in the business device 11, and the load tendency upon executing the respective jobs, and is prepared for each service (Web service, application service or database service). The job correlation table 44 is configured from, as shown in FIG. 5, a job column 44A, an average processing time column 44B, an extremely heavy load period column 44C, an exclusivity column 44D and a standby requirement column 44E.

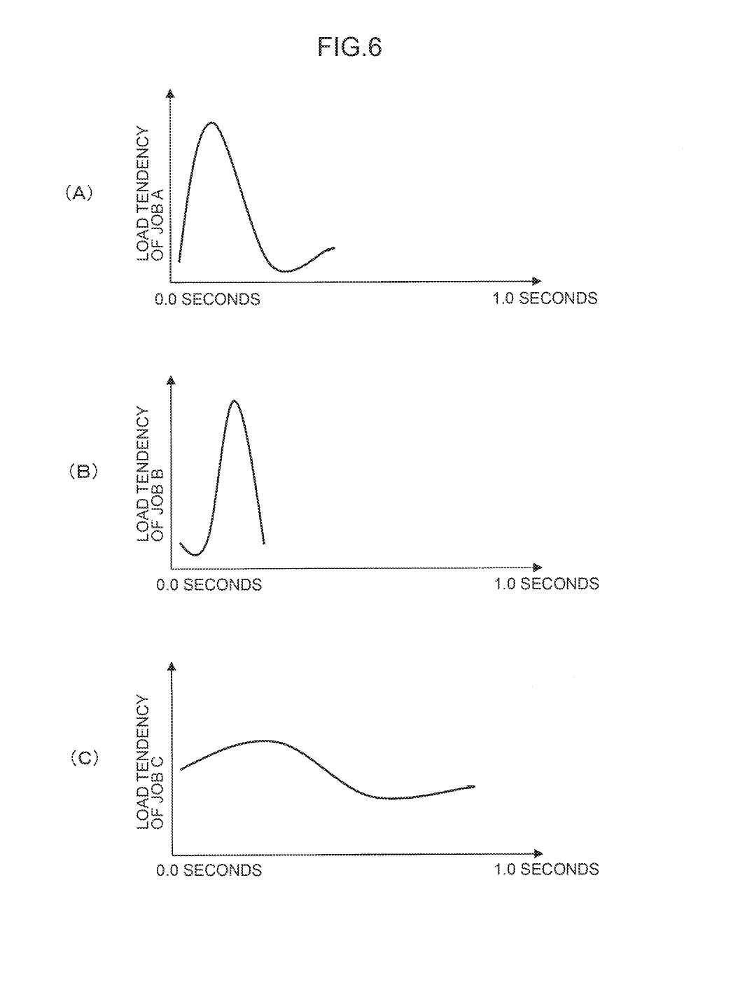

The job column 44A stores the job name of the respective jobs that can be executed in the business device 11 providing the corresponding service, and the average processing time column 44B stores the average processing time of the corresponding job. Moreover, the extremely heavy load period column 44C stores the period that the load becomes extremely heavy upon executing the corresponding job. In the case of this embodiment, with regard to “job A”, as shown in FIG. 6(A), the load of the business device 11 becomes extremely heavy between “0 seconds and 0.2 seconds” after execution, and with regard to “job B”, as shown in FIG. 6(B), the load of the business device 11 becomes extremely heavy between “0.2 seconds and 0.3 seconds” after execution, and with regard to “job C”, as shown in FIG. 6(C), the load of the business device 11 becomes extremely heavy between “0 seconds and 0.4 seconds” after execution.

In addition, the exclusivity column 44D stores whether there is any exclusivity with other jobs upon executing the corresponding job and, if there is such exclusivity, the period of such exclusivity. In addition, the standby requirement column 44E stores whether it is necessary for the other jobs to stand by upon executing the corresponding job and, if such standby is necessary, the period of such standby. In the case of this embodiment, when there is an overlap in the period of time that the load of the corresponding job becomes extremely heavy or exclusivity is set upon executing the corresponding job in such period of time, other correlated jobs need to stand by.

Accordingly, for instance, the example of FIG. 5 shows that, with the job referred to as “job A”, the average processing time is “0.5 seconds”, the load becomes extremely heavy between “0 seconds and 0.3 seconds, “0 to 0.2 seconds are exclusive with job B”, “job B needs to stand by between 0 seconds and 0.2 seconds” and “job C needs to stand by between 0 seconds and 0.3 seconds”.

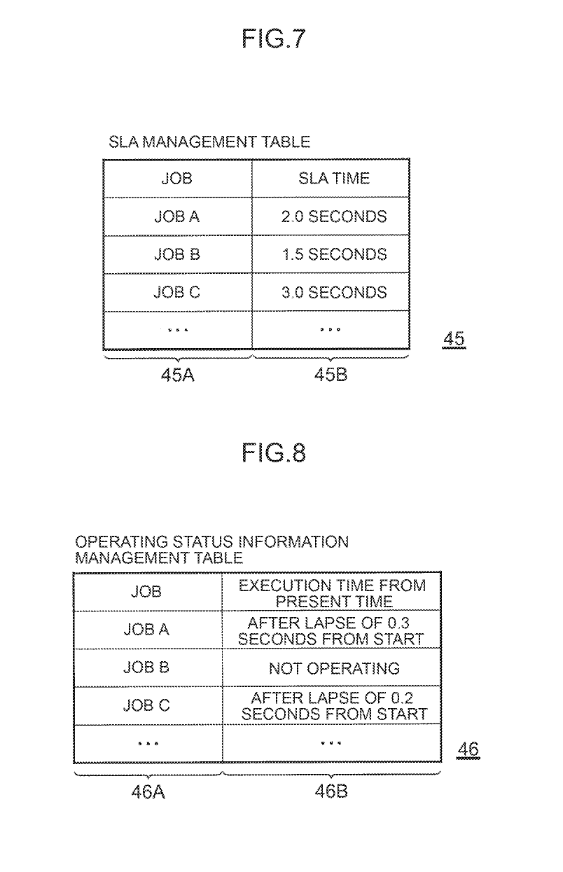

Moreover, the SLA information management table 45 is a table that is used for managing the SLA for each predetermined job, and is configured from, as shown in FIG. 7, a job name column 45A and an SLA time column 45B. The job name column 45A stores the job name of each job, and the SLA time column 45B stores the upper limit of the response time, which is prescribed in the SLA regarding the corresponding job, from the time that the business terminal 2 issues a request and the time that the result thereof is sent to the business terminal 2. Accordingly, the example of FIG. 7 shows that, with regard to the job referred to as “job A”, the upper time of the response time is “2.0 seconds”.

The operating status information management table 46 is a table that is used for specifically managing the execution of the respective jobs that can be executed in the corresponding business device 11 among the operating status information that the analyzing device 5 collected from the operating status collection device 10 of the monitoring target system 3, and is created for each business device 11. The operating status information management table 46 is configured from, as shown in FIG. 8, a job name column 46A and an execution time column 46B. The job name column 46A stores the job name of the respective jobs that can be executed in the corresponding business device 11, and the execution time column 46B stores the elapsed time from the time that the corresponding business device 11 started the execution of the corresponding job. Accordingly, the example of FIG. 8 shows that, with regard to “job A”, “0.3 seconds have elapsed from the start” at present (more accurately, as of the time that the operating status collection device 10 collected such information).

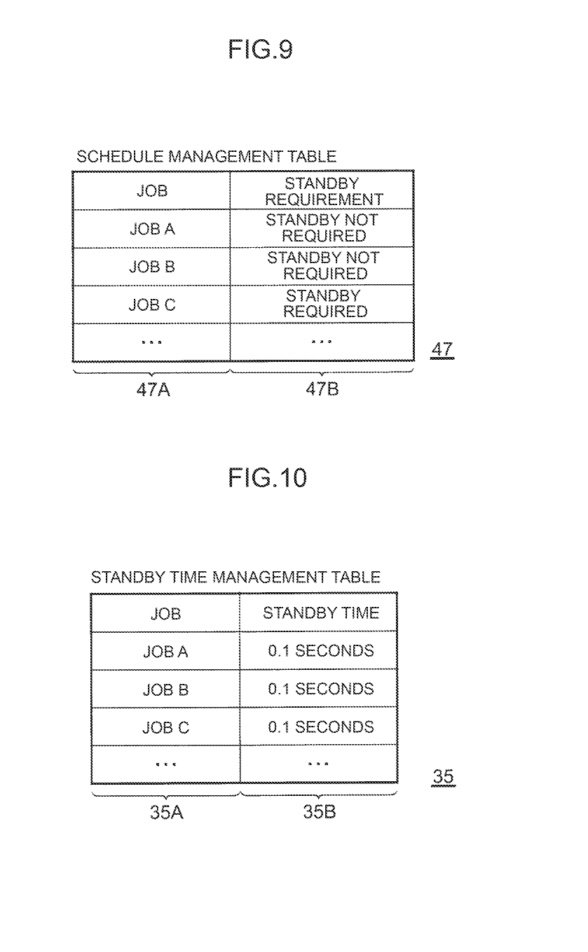

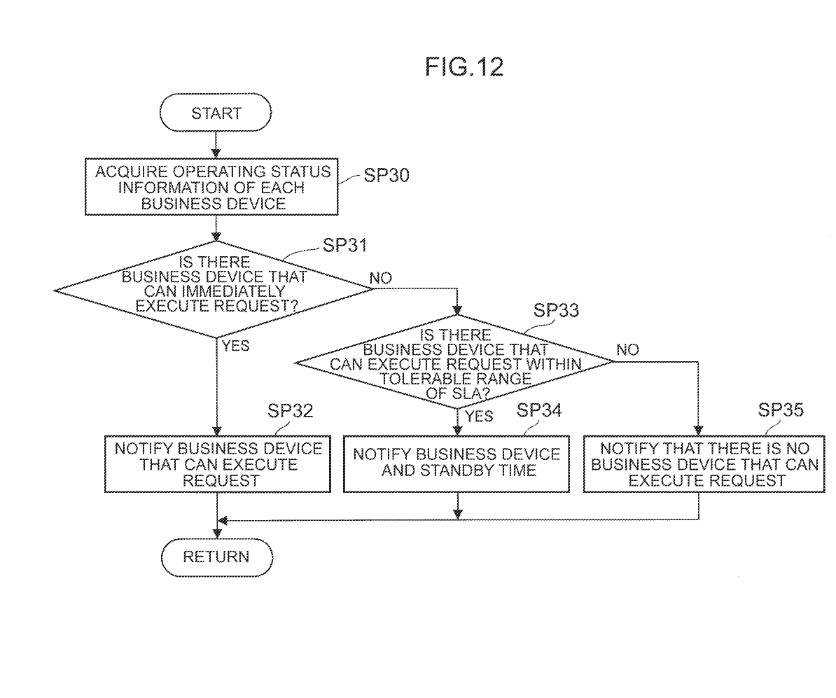

The schedule management table 47 is a table that is temporarily created in the course of the schedule creation processing (FIG. 12) described later, and is created for each business device 11 providing the relevant service. The schedule management table 47 is configured from, as shown in FIG. 9, a job name column 47A and a standby requirement column 47B.

The job name column 47A stores the job name of the respective jobs that can be executed in the corresponding business device 11, and the standby requirement column 47B stores information representing whether the corresponding job can be immediately executed by that business device 11 at present (“Standby not required” when the job can be immediately executed, and “Standby required” when the job cannot be immediately executed). Accordingly, the example of FIG. 9 shows that, in the corresponding business device 11, while “job A” and “job B” correspond to “Standby not required”, “job C” corresponds to “Standby required”.

Meanwhile, as means for realizing the foregoing system monitoring function, as shown in FIG. 3, the primary storage device 31 of the job scheduling device 4 stores a job scheduling processing unit 33, and the secondary storage device 32 of the job scheduling device 4 stores a request destination list 34 and a standby time management table 35.

The job scheduling processing unit 33 is a program having a function of sending a request to the designated business device 11 after standing by for the designated period as needed based on the schedule information from the analyzing device 5.

Moreover, the request destination list 34 is a list storing the device name and IP address of the respective business devices 11.

In addition, the standby time management table 35 is a table that is used for managing the standby time for each job that is notified from the analyzing device 5, and is configured from, as shown in FIG. 10, a job name column 35A and a standby time column 35B. The job name column 35A stores the job name of the respective jobs in which the transfer of the request is requested to the job scheduling device 4, and the standby time column 35B stores the standby time upon transferring the request regarding the corresponding job. Accordingly, the example of FIG. 10 shows that, with regard to the job referred to as “job A”, the request should be transferred to the business device 11, which was designated by the analyzing device 5, after standing by for “0.1 seconds”.

(3) Various Processing Related to System Monitoring Function

(3-1) Flow of System Monitoring Processing

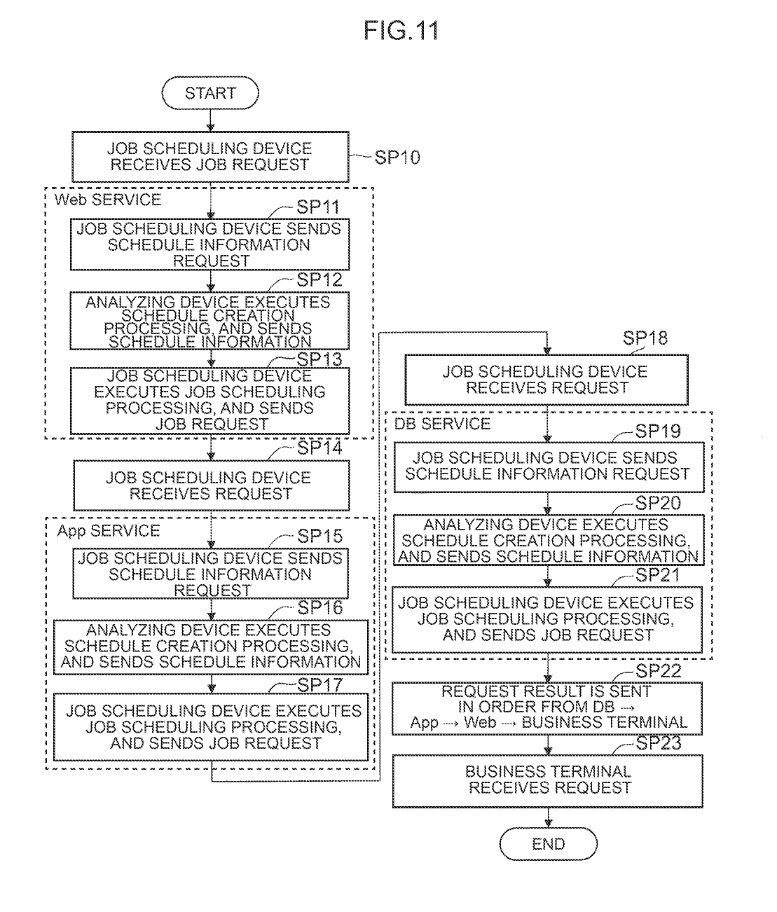

FIG. 11 shows an example of the flow of the system monitoring processing that is executed in the information system 1 according to the configuration of this embodiment. This example shows the flow of processing in a case where, in the monitoring target system 3, the business device 11 loaded with a Web service program 25 (this is hereinafter referred to as the “Web service business device 11” as appropriate) requests predetermined processing to the business device loaded with an application program 26 for processing the request from the business terminal 2 (this is hereinafter referred to as the “application service business device 11” as appropriate), the application service business device 11 requests predetermined processing to the business device 11 loaded with a database program 27 for processing the request from the Web service business device 11 (this is hereinafter referred to as the “database service business device 11” as appropriate), the application service business device 11 executes the processing based on the processing result of the database service business device 11, and the Web service business device 11 sends the processing result thereof to the business terminal 2 as the source of the request.

This system monitoring processing is started by the business terminal 2 sending a job request to the job scheduling device 4. When the job scheduling device 4 receives the job request (SP10), the job scheduling device 4 sends a schedule information request to the analyzing device 5 (SP11).

When the analyzing device 5 receives the schedule information request, the analyzing device 5 acquires the operating status information of the respective Web service business devices 11 by sending an operating status request to the operating status collection device 10 in the monitoring target system 3. Moreover, the analyzing device 5 creates schedule information regarding the job designated in the schedule information request based on the acquired operating status information and the Web service job correlation table 44. The analyzing device 5 subsequently sends the created schedule information to the job scheduling device 4 (SP12).

When the job scheduling device 4 receives the schedule information, the job scheduling device 4 sends a request to the Web service business device 11 in the monitoring target system 3 that was designated in the schedule information after standing by for the standby time when such standby time is designated in the schedule information (SP13).

Consequently, the Web service business device 11 that received the foregoing request sends a request to the job scheduling device 4 for causing the application service business device 11 to execute a predetermined job.

When the job scheduling device 4 receives the foregoing request (SP14), the job scheduling device 4 sends a schedule information request, in response to the foregoing request, to the analyzing device 5 (SP15).

When the analyzing device 5 receives the schedule information request, the analyzing device 5 acquires the operating status information of the respective application service business devices 11 by sending an operating status request to the operating status collection device 10 in the monitoring target system 3. Moreover, the analyzing device 5 creates schedule information regarding the job designated in the schedule information request based on the acquired operating status information and the application service job correlation table 44. The analyzing device 5 subsequently sends the created schedule information to the job scheduling device 4 (SP16).

When the job scheduling device 4 receives the foregoing schedule information, the job scheduling device 4 sends a request to the application service business device 11 in the monitoring target system 3 that was designated in the schedule information after standing by for the standby time when such standby time is designated in the schedule information (SP17).

Consequently, the application service business device 11 that received the foregoing request sends a request to the job scheduling device 4 for causing the database service business device 11 to execute a predetermined job.

When the job scheduling device 4 receives the foregoing request (SP18), the job scheduling device 4 sends a schedule information request, in response to the foregoing request, to the analyzing device 5 (SP19).

When the analyzing device 5 receives the schedule information request, the analyzing device 5 acquires the operating status information of the respective database service business devices 11 by sending an operating status request to the operating status collection device 10 in the monitoring target system 3. Moreover, the analyzing device 5 creates schedule information regarding the job designated in the schedule information request based on the acquired operating status information and the database service job correlation table 44. The analyzing device 5 subsequently sends the created schedule information to the job scheduling device 4 (SP20).

When the job scheduling device 4 receives the foregoing schedule information, the job scheduling device 4 sends a request to the database service business device 11 in the monitoring target system 3 that was designated in the schedule information after standing by for the standby time when such standby time is designated in the schedule information (SP21).

Consequently, the business device 11 that received the foregoing request executes the designated processing according to the request, and sends the processing result to the application service business device 11. Moreover, the application service business device 11 executes necessary processing based on the foregoing processing result, and sends the processing result to the Web service business device 11. The Web service business device 11 thereafter sends the processing result of the predetermined processing, which was sent from the application service business device 11, to the business terminal 2 as the source of the request (SP22).

Subsequently, the business terminal 2 receives the foregoing processing result (SP23), and the system monitoring processing is thereby ended.

(3-2) Schedule Creation Processing

FIG. 12 shows the specific processing routine of the schedule creation processing that is executed by the analyzing device 5 in step SP12, step SP16 and step SP20 of the system monitoring processing. The schedule creation processing is executed by the schedule creation processing unit 43 (FIG. 4) of the analyzing device 5.

In effect, when the schedule creation processing unit 43 proceeds to step SP12, step SP16 or step SP20 of the system monitoring processing, the schedule creation processing unit 43 starts the schedule creation processing shown in FIG. 12, and foremost accesses the operating status collection device 10 of the monitoring target system 3 to acquire the operating status information of the respective business devices 11 in the monitoring target system 3 providing the corresponding service (Web service, application service or database service), and stores, in the corresponding operating status information management table 46, information related to the job execution status among the acquired operating status information (SP30).

Next, the schedule creation processing unit 43 determines whether there is a business device 11 in the monitoring target system 3 capable of immediately executing the job designated in the schedule information request from the job scheduling device 4 based on the operating status information of each of the corresponding business devices 11 acquired in step SP30 and the relevant service job correlation table 44, while giving consideration to the CPU utilization and unused capacity of the memory of the business device 11, and the exclusive relation with the job that is currently running on the business device 11 (SP31).

When the schedule creation processing unit 43 obtains a positive result in this determination, the schedule creation processing unit 43 sends, to the job scheduling device 4, schedule information which designates that business device 11 as the business device 11 to execute the corresponding job (SP32), and thereafter ends the schedule creation processing and returns to the system monitoring processing.

Meanwhile, when the schedule creation processing unit 43 obtains a negative result in the determination of step SP31, the schedule creation processing unit 43 refers to the SLA information management table 45 (FIG. 7), and determines whether there is a business device 11 in the monitoring target system 3 capable of executing the job designated in the schedule information request from the job scheduling device 4 by delaying the processing to the extent permitted under the SLA (SP33).

When the schedule creation processing unit 43 obtains a positive result in this determination, the schedule creation processing unit 43 sends, to the job scheduling device 4, schedule information which designates that business device 11 as the business device 11 to execute the corresponding job, as well as the standby time, and thereafter ends the schedule creation processing and returns to the system monitoring processing.

Meanwhile, when the schedule creation processing unit 43 obtains a negative result in the determination of step SP33, the schedule creation processing unit 43 sends, to the job scheduling device 4, schedule information to the effect that there is currently no business device 11 capable of executing the job designated in the schedule information request (SP35), and thereafter ends the schedule processing and returns to the system monitoring processing.

(3-3) Business Scheduling Processing

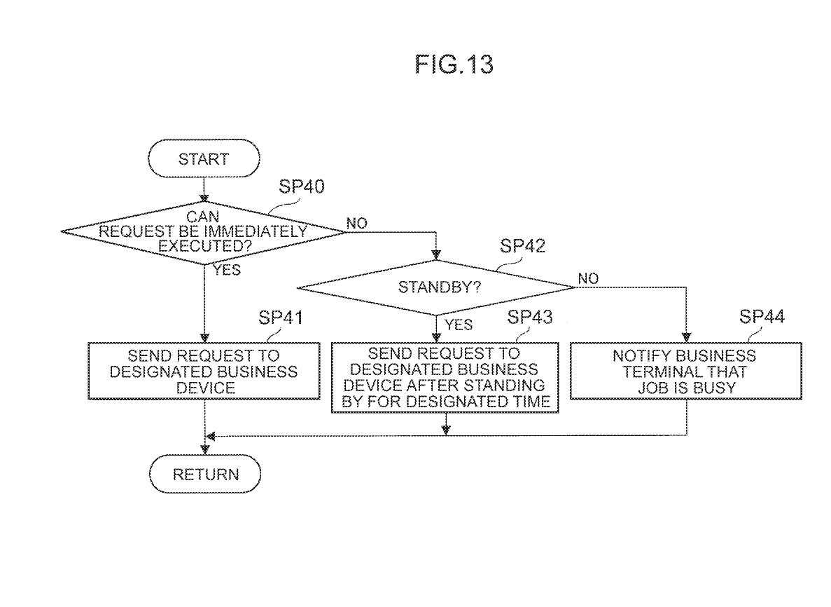

Meanwhile, FIG. 13 shows the specific processing routine of the job scheduling processing that is executed by the job scheduling device 4 in step SP13, step SP17 and step SP21 of the system monitoring processing. The job scheduling processing is executed by the job scheduling processing unit 33 (FIG. 3) of the job scheduling device 4.

In effect, when the job scheduling processing unit 33 receives the schedule information from the analyzing device 5, the job scheduling processing unit 33 starts the job scheduling processing, and foremost determines, based on the received schedule information, whether a business device 11 capable of immediately executing the job requested from the business terminal 2 or the business device 11 (SP40).

When the job scheduling processing unit 33 obtains a positive result in this determination, the job scheduling processing unit 33 sends the request from the business terminal 2 or the business device 11 to the business device 11 designated in the schedule information (SP41), and thereafter ends the job scheduling processing and returns to the system monitoring processing.

Meanwhile, when the job scheduling processing unit 33 obtains a negative result in the determination of step SP40, the job scheduling processing unit 33 determines whether a standby time is designated in that schedule information (SP42). When the job scheduling processing unit 33 obtains a positive result in this determination, the job scheduling processing unit 33 sends the request from the business terminal 2 or the business device 11 to the business device 11 designated in the schedule information after standing by for the period designated in the schedule information (SP43). The job scheduling processing unit 33 thereafter ends the job scheduling processing and returns to the system monitoring processing.

Meanwhile, when the job scheduling processing unit 33 obtains a negative result in the determination of step SP42 (that is, when the received schedule information describes that there is no business device 11 capable of executing the corresponding job), the job scheduling processing unit 33 notifies the business terminal 2 that the job is busy (SP44), and thereafter ends the job scheduling processing. Note that, when the job scheduling processing is ended via step SP44, the system monitoring processing is also ended.

(4) Effect of this Embodiment

As described above, with the information system 1 of this embodiment, the business device 11 to execute the job requested from the business terminal 2 or the like is decided based on the operating status of the respective business devices 11 in the current monitoring target system 3, and the exclusive relation between jobs and the load tendency of each job, and that business device 11 is requested to execute that job.

Thus, according to the information system 1, is to possible to reduce the occurrence of deadlocks and exclusive waiting, and thereby reduce the occurrence of job delays.

(5) Other Embodiments

While the foregoing embodiments described a case of applying the present invention to an information system 1 configured as illustrated in FIG. 1, the present invention is not limited thereto, and may also be broadly applied to information systems of various other configurations.

Moreover, while the foregoing embodiments described a case of configuring the job scheduling device 4 and the analyzing device 5 as individual devices, the present invention is not limited thereto, and the functions of the job scheduling device 4 and the analyzing device 5 may also be loaded in a single device.

### INDUSTRIAL APPLICABILITY

The present invention can be applied to an information system including one or more business devices capable of executing a plurality of jobs having an exclusive relation, and a business terminal for requesting execution of the jobs to the business device.

### REFERENCE SIGNS LIST

1 . . . information system, 2 . . . business terminal, 3 . . . monitoring target system, 4 . . . job scheduling device, 5 . . . analyzing device, 10 . . . operating status collection device, 11 . . . business device, 20, 23, 30, 40 . . . CPU, 25 . . . Web service program, 26 . . . application service program, 27 . . . database service program, 33 . . . job scheduling processing unit, 35 . . . standby time management table, 43 . . . schedule creation processing unit, 44 . . . job correlation management table, 45 . . . SLA information management table, 46 . . . operating status information management table, 47 . . . schedule management table.

1. A monitoring method of monitoring an information system including one or more business devices capable of executing a plurality of jobs having an exclusive relation, and a business terminal for requesting execution of the jobs to the business device, wherein the information system includes:
a job scheduling device which receives a job execution request sent from the business terminal; and
an analyzing device which retains first information related to the exclusive relation between the jobs and a load tendency of each of the jobs,
wherein the monitoring method comprises:
a first step of the job scheduling device making an inquiry to the analyzing device regarding to which one of the business devices the request from the business terminal should be transferred;
a second step of the analyzing device acquiring second information related to an operating status of the business device from the operating status collection device of the monitoring target system, and notifying to the job scheduling device, based on the acquired second information and the retained first information, the business device to which the request should be transferred and, as needed, a standby time that is required upon transferring the request; and
a third step of the job scheduling device transferring the request to the designated business device after standing by for the designated standby time, in case the standby time is designated, based on the notice from the analyzing device.

2. The monitoring method according to claim 1,
wherein, in the second step, the analyzing device:
determines whether there is a business device among the business devices capable of immediately executing the job designated in the request from the business terminal based on the first and second information;
notifies, in case there is a business device capable of immediately executing the job, that business device as a transfer destination of the request to the job scheduling device, and determines, when there is no business device capable of immediately executing the job, whether there is a business device among the business devices capable of executing the job by standing by within a range in which a response time to the request does not exceed a predetermined upper limit; and
notifies, in case there is a business device capable of executing the job by standing by within a range in which the response time to the request does not exceed a predetermined upper limit, that business device as a transfer destination of the request, and a standby time, to the job scheduling device.

3. The monitoring method according to claim 2,
wherein, in the second step, the analyzing device:
notifies, in case there is no business device capable of executing the job by standing by within a range in which the response time to the request does not exceed a predetermined upper limit, the job scheduling device that there is currently no business device capable of executing the requested job, and
wherein, in the third step, the job scheduling device:
notifies, upon being notified from the analyzing device that there is currently no business device capable of executing the requested job, the business terminal that there is currently no business device capable of executing the requested job, without transferring the request to the business device.

4. The monitoring method according to claim 2,
wherein the upper limit of the response time to the request is a time prescribed in an SLA (Service Level Agreement).

5. The monitoring method according to claim 1,
wherein the information system includes a plurality of business devices, and
wherein the monitoring method further comprises:
a fourth step of the business device that received the request from the job scheduling device sending, to the job scheduling device, an execution request of a job to be executed by another business device in order to execute the job designated in the request;
a fifth step of the job scheduling device making an inquiry to the analyzing device regarding to which one of the business devices that request should be transferred;
a sixth step of the analyzing device acquiring the second information related to an operating status of the corresponding business device from the operating status collection device of the monitoring target system, and notifying to the job scheduling device, based on the acquired second information and the retained first information, the business device to which the request should be transferred and, as needed, a standby time required upon transferring the request; and
a seventh step of the job scheduling device transferring the request to the designated business device after standing by for the designated standby time, in case the standby time is designated, based on the notice from the analyzing device.

6. The monitoring method according to claim 5,
wherein processing of the step SP4 to the step SP7 is repeated as needed.

7. A monitoring system for monitoring an information system including one or more business devices capable of executing a plurality of jobs having an exclusive relation, and a business terminal for requesting execution of the jobs to the business device, wherein the monitoring system comprises:
a job scheduling device which receives a job execution request sent from the business terminal; and
an analyzing device which retains first information related to the exclusive relation between the jobs and a load tendency of each of the jobs,
wherein the job scheduling device makes an inquiry to the analyzing device regarding to which one of the business devices the request from the business terminal should be transferred;
the analyzing device acquires second information related to an operating status of the business device from the operating status collection device of the monitoring target system, and notifies to the job scheduling device, based on the acquired second information and the retained first information, the business device to which the request should be transferred and, as needed, a standby time required upon transferring the request; and
the job scheduling device transfers the request to the designated business device after standing by for the designated standby time, in case the standby time is designated, based on the notice from the analyzing device.

8. The monitoring system according to claim 7,
wherein the analyzing device:
determines whether there is a business device among the business devices capable of immediately executing the job designated in the request from the business terminal based on the first and second information;
notifies, in case there is a business device capable of immediately executing the job, that business device as a transfer destination of the request to the job scheduling device, and determines, in case there is no business device capable of immediately executing the job, whether there is a business device among the business devices capable of executing the job by standing by within a range in which a response time to the request does not exceed a predetermined upper limit; and
notifies, in case there is a business device capable of executing the job by standing by within a range in which the response time to the request does not exceed a predetermined upper limit, that business device as a transfer destination of the request, and a standby time to the job scheduling device.

9. The monitoring system according to claim 8,
wherein the analyzing device:
notifies, in case there is no business device capable of executing the job by standing by within a range in which the response time to the request does not exceed a predetermined upper limit, the job scheduling device that there is currently no business device capable of executing the requested job, and
wherein the job scheduling device:
notifies, upon being notified from the analyzing device that there is currently no business device capable of executing the requested job, the business terminal that there is currently no business device capable of executing the requested job without transferring the request to the business device.

10. The monitoring system according to claim 8,
wherein the upper limit of the response time to the request is a time prescribed in an SLA (Service Level Agreement).

11. The monitoring system according to claim 7,
wherein the information system includes a plurality of business devices, and
wherein:
the business device, which received the request from the job scheduling device, sends an execution request of a job to be executed by another business device to the job scheduling device in order to execute the job designated in the request;
the job scheduling device makes an inquiry to the analyzing device regarding to which one of the business devices that request should be transferred;
the analyzing device acquires the second information related to an operating status of the corresponding business device from the operating status collection device of the monitoring target system, and notifies to the job scheduling device, based on the acquired second information and the retained first information, the business device to which the request should be transferred and, as needed, a standby time that is required upon transferring the request; and
the job scheduling device transfers the request to the designated business device after standing by for the designated standby time, in case the standby time is designated, based on the notice from the analyzing device.
